(19) United States
(12) Patent Application Publication
(10) Pub. No.: US 2007/0131913 A1
(43) Pub. Date: Jun. 14, 2007

(54) THERMAL INTERFACE MATERIAL AND SEMICONDUCTOR DEVICE INCORPORATING THE SAME

(75) Inventors: Ching-Tai Cheng, Tu-Cheng,Taipei Hsien (TW); Nien-Tien Cheng, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/462,673

(22) Filed: Aug. 4, 2006

(30) Foreign Application Priority Data
Dec. 9, 2005 (CN) 200510102339.3

(51) Int. Cl. H01B 1/12

(52) U.S. Cl. 252/500

(57) ABSTRACT

A semiconductor device (10) includes a heat source (12), a heat-dissipating component (13) for dissipating heat generated by the heat source, and a thermal interface material (14) filled in a space formed between the heat source and the heat-dissipating component. The thermal interface material includes a mixture of first copper powders having an average particle size of 2 um and second copper powders having an average particle size of 5 um, a silicone oil having a viscosity from 50 to 50,000 cs at 25° C., and at least one oxide powder selected from the group consisting of zinc oxide and alumina powders. The mixture of copper powders is 50% to 90% in weight, the silicone oil is 5% to 15% in weight and the at least one oxide powder is 0% to 35% in weight of the thermal interface material.

### FIELD OF THE INVENTION

The present invention relates to a thermal interface material which is interposable between a heat-generating electronic component and a heat dissipating component, and it also relates to a semiconductor device using the thermal interface material.

### DESCRIPTION OF RELATED ART

With the fast development of the electronic industry, advanced electronic components such as CPUs (central processing units) are being made to have ever quicker operating speeds. During operation of the advanced electronic components, much heat is generated. In order to ensure good performance and reliability of the electronic components, their operational temperature must be kept within a suitable range. Generally, a heat dissipating apparatus such as a heat sink or a heat spreader is attached to a surface of the electronic component, so that the heat is transferred from the electronic component to ambient air via the heat dissipating apparatus. However, the contact surfaces between the heat dissipating apparatus and the electronic component are rough and therefore are separated from each other by a layer of interstitial air, no mater how precisely the heat dissipating apparatus and the electronic component are brought into contact; thus, the contact thermal resistance is relatively high. A thermal interface material is preferred for being applied to the contact surfaces to eliminate the air interstice between the heat dissipating apparatus and the electronic component in order to improve heat dissipation.

The thermal interface material includes a base oil and a filler filled in the base oil. Thereinto, the base oil is used for filling the air interstice to perform an intimate contact between the heat dissipating apparatus and the electronic component, whilst the filler is used for improving the thermal conductivity of the thermal interface material to thereby increase the heat dissipation efficiency of the heat dissipating apparatus. Therefore, the filler having a high thermal conductivity is the preferred choice in improving the thermal conductivity of the thermal interface material.

### SUMMARY OF THE INVENTION

The present invention relates to a thermal interface material for electronic products and a semiconductor device using the thermal interface material. According to a preferred embodiment of the present invention, the semiconductor device includes a heat source, a heat-dissipating component for dissipating heat generated by the heat source, and a thermal interface material filled in a space formed between the heat source and the heat-dissipating component. The thermal interface material includes a mixture of first copper powders having an average particle size of 2 um and second copper powders having an average particle size of 5 um, and a silicone oil having a viscosity from 50 to 50,000 cs at 25° C. The mixture of copper powders is filled in the silicone oil, and is 50% to 90% in weight of the thermal interface material. The silicon oil is 5% to 15% in weight of the thermal interface material. The thermal interface material can further include 0% to 35% in weight of oxide powders therein.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present thermal interface material can be better understood with reference to the following drawings. The components in the drawings are not necessarily drawn to scale, the emphasis instead being placed upon clearly illustrating the principles of the present thermal interface material. Moreover, in the drawings, like reference numerals designate corresponding parts throughout the several views.

FIG. 1 is an explanatory assembled view of a semiconductor device according to a preferred embodiment of the present invention.

### DETAILED DESCRIPTION OF THE INVENTION

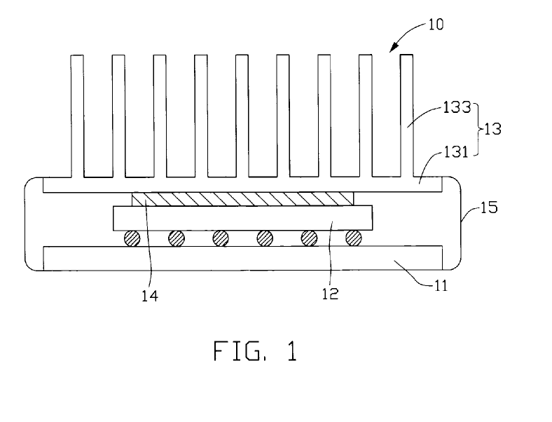

Referring to FIG. 1, an electronic device 10 includes a heat source 12 disposed on a circuit board 11, a heat-dissipating component 13 for dissipating heat generated by the heat source 12, and a thermal interface material 14 filled in a space formed between the heat source 12 and the heat-dissipating component 13. The heat source 12 is an electronic component, such as a central processing unit (CPU) of a computer, which needs to be cooled. The heat-dissipating component 13 is a heat sink, which includes a base 131 and a plurality of fins 133 disposed on the base 131. The heat-dissipating component 13 is attached to the circuit board 11 via a resilient fixing member 15, which is able to deform to provide a resilient force. The base 131 of the heat-dissipating component 13 is sandwiched between the fixing member 15 and the circuit board 11, and is urged downwardly towards the heat source 12 on the circuit board 11 via the resilient force exerted thereon by the fixing member 15. The thermal interface material 14 is pressed by the heat-dissipating component 13, thus filled in the space formed between the heat source 12 and the heat-dissipating component 13.

The thermal interface material 14 is of silicone grease composition having high thermal conductivity, and includes a base oil and a filler filled in the base oil.

The base oil is 5% to 15% in weight of the thermal interface material 14; that is, the base oil is no less than 5% in weight but no more than 15% in weight of the thermal interface material 14. The base oil is silicon oil which has viscosity in the range of 50 to 50,000 cs at 25° C. The major component of the silicon oil is organopolysiloxanes, whose formula is RₐSiO_{(4-a)/2}. Alternatively, the silicon oil may be organopolysilalkylenes, organopolysilanes, or copolymers. In the formula, R presents hydrocarbon group, which polymerizes with siloxanes to acquire corresponding organopolysiloxane, such as dimethylpolysiloxane, diethylpolysiloxane, methylphenylpolysiloxane, dimethylsiloxanediphenylsiloxane copolymers, alkyl-modified methylpolysiloxane, or etc. In this embodiment, the organopolysiloxane is dimethylpolysiloxane, which is the major component of the dimethyl silicone oil. Alternatively, the R may present amino group, polyether group, epoxy group, or etc in the formula.

The filler is 50% to 90% in weight of the thermal interface material 14; that is, the filler is no less than 50% in weight but no more than 90% in weight of the thermal interface material 14. The filler is a mixture of substantially spherical-shaped first copper powders having an average particle size of 2 um and substantially spherical-shaped second copper powders having an average particle size of 5 um. The weight ratio of the first and second copper powders is in a range of 1:1 to 1:10.

The thermal interface material 14 further includes no more than 35% in weight of oxide powders having an average particle size of 0.1 to 5 um selected from the group consisting of zinc oxide and alumina powders. Alternatively, there may be no oxide powders filled in the base oil.

In the present thermal interface material 14, the filler is mixture of first and second copper powders, which having high thermal conductivities. The heat resistance of the thermal interface material 14 is therefore decreased, and the thermal conductivity of the thermal interface material 14 is accordingly increased. Hereinafter, experimental data is provided to validate such a result.

Table 1 below shows characters such as thermal conductivity, electrical resistance, dielectric constant, coefficient of thermal expansion (CTE), and disadvantages of the materials in experiment. Preferred filler is selected according to these characters. Table 1 shows that copper is the preferred filler, due to its high thermal conductivity and low electrical resistance.

TABLE 1

| | Thermal | Electrical | Dielectric | CTE | |
|---|---|---|---|---|---|
| | conductivity | Resistance | Constant | (ppm/ | Disadvan- |
| Property | (W/mK) | (ohm-cm) | (1 MHz) | ° C.) | tages |
| BN | 60; 250˜300 | | | <0.5 | Expensive |
| AlN | 130˜260 | > = 10¹⁴ | 8.7˜8.9 | 4.4 | |
| BeO | 250 | 10¹⁴ | 6.7 | 7.5 | Toxicity |
| SiC | 90˜270 | > = 10¹³ | 40 | 3.7 | |
| ZnO | 20 | | | | |
| Al₂O₃ | 20˜36 | 10¹⁴ | 9.4 | 4.4˜6.5 | |
| Si₃N₄ | 30 | > = 10¹⁴ | 8.0 | 3.0 | Expensive |
| h-BN | 20 | > = 10¹¹ | 4.1 | 0 | |
| Al | 235 | 2.68*10⁻⁶ | | | |
| Cu | 400 | 1.7*10⁻⁶ | | | |

Table 2 below shows heat resistances of thermal interface materials with different fillers. Table 2 shows that the heat resistance of the present thermal interface materials I and II are lower than those of the conventional thermal interface materials I and II.

TABLE 2

| | | | | Thermal |
|---|---|---|---|---|
| | | | Added | resistance |
| Thermal interface material | Base oil | Fillers | amount | (° C. · cm²/w) |
| The present thermal | dimethyl silicone oil | Cu I + Cu II | 50 vol % | 0.400 |
| interface material (I) | viscosity: 10,000 cs | | | |
| The present thermal | dimethyl silicone oil | Cu I + Cu II + ZnO | 55 vol % | 0.332 |
| interface material (II) | viscosity: 30,000 cs | | | |
| Conventional thermal | dimethyl silicone oil | Al₂O₃ having an | 50 vol % | 0.618 |
| interface material (I) | viscosity: 10,000 cs | average particle | | |
| | | size of 5.0 μm | | |
| Conventional thermal | dimethyl silicone oil | ZnO having an | 30 vol % | 0.860 |
| interface material (II) | viscosity: 10,000 cs | average particle | | |
| | | size of 0.4 μm | | |

Remark The viscosity of the base oil is measured at 25° C.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of portions within the principles of the invention to the full extent indicated by the broad general meaning of the terms in which the appended claims are expressed.

What is claimed is:

1. A thermal interface material comprising:
a base oil being 5% to 15% in weight of the thermal interface material; and
a filler filled in the base oil and being 50% to 90% in weight of the thermal interface material, wherein the filler is a mixture of first copper powders having an average particle size of 2 um and second copper powders having an average particle size of 5 um; and
at least one oxide powder being 0% to 35% in weight of the thermal interface material.

2. The thermal interface material as described in claim 1, wherein the base oil has a viscosity from 50 to 50,000 cs at 25° C.

3. The thermal interface material as described in claim 1, wherein the base oil is silicone oil.

4. The thermal interface material as described in claim 3, wherein a major component of the silicone oil is organopolysiloxane.

5. The thermal interface material as described in claim 4, wherein the organopolysiloxane is dimethylpolysiloxane.

6. The thermal interface material as described in claim 1, wherein a weight ratio of the first copper powders and the second copper powders is in a range of 1:1 to 1:10.

7. The thermal interface material as described in claim 1, wherein an average particle size of the oxide powder is in the range from 0.1 to 5 μm.

8. The thermal interface material as described in claim 1, wherein the oxide powder is selected from the group consisting of zinc oxide and alumina powders.

9. A semiconductor device comprising:
a heat source;
a heat-dissipating component for dissipating heat generated by the heat source; and
a thermal interface material filled in a space formed between the heat source and the heat-dissipating component, the thermal interface material comprising:
a mixture of first copper powders having an average particle size of 2 um and second copper powders having an average particle size of 5 um, the mixture being 50% to 90% in weight of the thermal interface material;
a silicone oil having a viscosity from 50 to 50,000 cs at 25° C., the silicone oil being 5% to 15% in weight of the thermal interface material; and
at least one oxide powder having an average particle size of 0.1 to 5 μm selected from the group consisting of zinc oxide and alumina powders, the at least one oxide powder being 0% to 35% in weight of the thermal interface material.

10. The semiconductor device as described in claim 9, wherein a major component of the silicone oil is organopolysiloxane.

11. The semiconductor device as described in claim 10, wherein the organopolysiloxane is dimethylpolysiloxane.

12. The semiconductor device as described in claim 11, wherein a weight ratio of the first and second copper powders is in a range of 1:1 to 1:10.
